(19) United States
(12) Patent Application Publication
(10) Pub. No.: US 2011/0088839 A1
(43) Pub. Date: Apr. 21, 2011

(54) MACHINE AND A METHOD FOR FILLING CONTAINMENT PANELS WITH TILES TO FORM MOSAIC PATTERNS

(76) Inventors: Luciano Morini, Firenze (IT); Jovanka Pizzo, Vinci (IT)

(21) Appl. No.: 12/988,675

(22) PCT Filed: Jan. 7, 2009
(86) PCT No.: PCT/IT2009/000001

§ 371 Date: Jan. 6, 2011

(30) Foreign Application Priority Data
Apr. 21, 2008 (IT) PCT/IT2008/000271

(51) Int. Cl. B44B 9/00; B28B 11/00

(52) U.S. Cl. 156/297; 156/363

(57) ABSTRACT

A machine fulfilling containment panels (P; P1-Pn) with a plurality of sets of tiles (T; T1, T2, T3), each of said sets of tiles (T; T1, T2, T3) having at least one previously selected characteristic in order to produce a mosaic pattern, comprising at least one remover system (3Z) suitable for removing from said panels (P) any of said tiles (T; T1, T2, 13) occupying positions other than as required.

### TECHNICAL FIELD

The present invention concerns a machine and a related method for filling a containment panel with mosaic tiles for tiling walls and floors of civil and industrial buildings, commercial buildings, exhibition areas, swimming pools or other such environments.

### BACKGROUND ART

Ever since very ancient times, there have been mosaic products made with tiles or tesserae, even of very limited dimensions, e.g. with sides of the order of a few dozen millimeters, used for tiling walls or floors, mainly for decorative purposes.

One side of these tiles remains in view and is decorated, i.e. it may, for instance, be colored, polished or enameled, to form an ornamental pattern that is visible when the tiles are applied to the wall or floor.

In an attempt to reduce the time it takes to manually install mosaics and the need to employ numerous, costly specialist workers, machines have been constructed with more or less advanced degrees of automation, designed to produce panels of mosaic tiles in which at least a supporting film is applied to the side that will remain in view of the tiles already arranged inside the panel, see for instance EP-B-1179439.

The panel of tiles can consequently be attached to the wall being tiled from the side free of the supporting film, which is subsequently removed from the tiles, once they have adhered to the wall. A faster and more straightforward installation is thus achieved than when the manual procedure is used.

Moreover, machines have been studied that enable an automation of the procedure for filling these panels with tiles so as to make the installation of such mosaics even quicker and easier.

EP-A-1493696 discloses a machine for filling trays with mosaic tiles that comprises a first continuous conveyor of tiles, a second continuous conveyor of trays for containing said tiles and an automated manipulator for transferring the tiles from the first conveyor onto the trays. The manipulator for transferring the tiles is fitted with a suction unit comprising a row of suckers associated with a suction circuit and arranged at a suitable distance from one another so as to collect the tiles from the first conveyor and deposit them in the trays.

Using the above-described type of machine, the tiles are randomly deposited on a containment panel, so it is not possible to produce mosaics with geometrical shapes or colored patterns.

Despite such technological developments, therefore, it is still difficult and the need is still felt to develop a machine for filling containment panels with tiles in an orderly manner to enable a more versatile and efficient automated installation of mosaics than the currently known methods.

### SUMMARY OF THE INVENTION

One object of preferred embodiments of the invention is to provide a machine and a related method for automatically filling panels with mosaic tiles for tiling walls and floors that is more efficient and has more advanced functions than the known machines.

This object and these advantages are achieved substantially by a machine for filling panels with mosaic tiles according to the independent claims. The dependent claims refer to additional particularly advantageous embodiments and features of the invention.

The invention concerns a machine for sequentially filling containment panels, as they move forward, with a plurality of sets of tiles (each set having at least one previously-selectable characteristic so as to create a mosaic pattern), comprising at least one remover system suitable for ejecting, i.e. removing, any tiles from the panel that occupy positions other than as required for the pattern, identified by means of a viewing system. The tile can be erroneously positioned e.g. because it is placed upside down, or because it does not correspond to the color required in a given seat or position, or else because it is damaged. In some preferred embodiments, the remover system is designed to individually remove such tiles and to perform thereon different alternative operations depending upon needs. For example, if the tile is a wrong one, e.g. it has a wrong color, or is damaged, said tile can be discarded, removed or rejected. If, however, the tile is simply arranged in the upside-down arrangement, it can be overturned, by the remover system. In this case the remover system can be controlled and designed to remove the individual tile and reposition it in the correct position, i.e. with the correct side facing upwards.

According to other embodiments, the machine provides a remover system designed and controlled to perform individual removal, replacement or re-positioning of tiles which have been placed in the panel by a different machine, such as a state-of-the-art machine. E.g. an existing tile processing line can be upgraded by adding a final module comprised of a machine according to the invention, with a remover system and preferably a viewing system such as a digital camera interfaced with a control unit. The final module can check each panel to locate broken or wrongly positioned tiles and the remover system can be controlled to remove, replace, or re-positioning the tiles.

In the preferred embodiments, the machine according to the invention also includes at least one viewing system designed to identify any tiles occupying positions other than as required in the panel according to said previously-selectable characteristics.

In particular, the viewing system can advantageously be used at least to check whether the tiles occupy the required positions on the panel and to identify any tiles occupying positions other than as required, based on said previously-selectable characteristics.

In some embodiments, the preferred previously-selectable characteristics are the color of the tiles in each set, so that sets of different-colored tiles can be combined in order to create a mosaic with geometrical shapes or colored patterns; clearly, this does not rule out the possibility of said characteristics being of some other type, such as the shape of the tiles, and so on.

The layout of the containment panel may be of the type comprising a grid with housing seats for containing each tile. In some embodiments through holes in each seat are provided to enable the remover system to eject the tiles. Clearly, the panels may nonetheless be made of any other type, depending on particular structural needs or uses.

In preferred embodiments of the present invention, the remover system may be tiltable with respect to the horizontal to take a settable inclined position, such that a panel arranged in front of the remover system will also take an inclined position with respect to the horizontal.

In some embodiments, the remover system is combined to a robot which moves the remover system along a suitable number of numerically controlled axes, e.g. according to Cartesian coordinates to displace a remover element on a first plane placed underneath or above the panel and substantially parallel thereto, in order to eject or remove at least one tile at a time from said panel. The robot can use a different type of coordinate system to displace the remover element, for example polar coordinates or the like.

In an advantageous embodiment, there is also a recovery system designed to retain the tile just ejected, i.e. removed from the panel to prevent it from dropping back onto said panel.

The aforesaid viewing system advantageously and preferably comprises a viewing device comprised of a TV camera and an electronic unit, and it is arranged upstream from the remover system, so as to view the panel and verify the filling of the panel, identifying any tiles that come to occupy positions other than as required on the panel, based on the previously-selected characteristics (the color or shape of each tile, or other characteristics).

In a particularly advantageous embodiment, the machine for filling the panels comprises a processing and control system suitable for producing an electronic simulation of the mosaic as created by means of the panels of tiles and displaying said simulation on a screen, and designed to control the filling machine. The machine can also advantageously comprise a final module capable of conducting an automated check on the panels completely filled with tiles, and designed to eject and replace any tiles that have yet to be positioned correctly, or that are found damaged or upside down. This does not rule out the possibility, however, of this final module being associated with a filling machine of a different type from the one described herein.

In another particularly advantageous embodiment, said remover system comprises at least one remover element able to: pick up any of the tiles that are still not correctly positioned and replace it in a required seat of the panel; remove any of the tiles occupying seats other than as required in the panel; remove any of the tiles that are found damaged; pick up any of the tiles that is reversed in its seat, reverse it upside down and then put it in the same seat. This remover element can include a sucker able to suck air to pick up at least one of the tiles, or similar device.

Advantageously, in some embodiments the remover system comprises a control system able to move said remover element so as to pick up a predetermined tile from a lateral container for inserting it in an empty seat of the panel. In this way the degree of automation of the system is higher because is possible to insert automatically a new tile in the panel without the need of a operator to control the process.

In a particularly advantageous embodiment, the remover system comprises also at least a tipping or overturning device able to reverse upside down and to drop the tile released from the remover element in the same seat. This tipping or overturning system is movable preferably under the remover element and above the panel.

In an advantageous embodiment of the invention, the tipping or overturning system includes a box comprised of a path or passageway for the tile with an upper opening, a lower opening and at least a contrast element positioned non-centrally between the upper opening and the lower opening in order to reverse the tile released by the remover element. The upper opening and the lower opening are slightly wider than the dimension of the tiles to permit accurate passage of the tile.

In some embodiments the contrast element is comprised of a small bar or shaft or two opposite tabs extending between the upper and lower opening.

According to another aspect, the invention relates to a method for automatically and sequentially filling a plurality of panels with a plurality of sets of tiles, each set having at least one previously-selectable characteristic, in order to create a mosaic with geometrical shapes or patterns, in various colors.

This method advantageously includes at least one initial phase, in which an electronic simulation of the mosaic is provided, and a filling phase involving the random filling of a containment panel with a plurality of sets of tiles, subsequently verifying the position actually occupied by each of the tiles on the panel by comparing it with the simulation so as to identify the position on the panel of any tiles that need to be removed, then ejecting any such tiles by means of said remover system.

The above-described filling phases can be repeated in sequence to fill the same panel with a plurality of sets of tiles with different characteristics (e.g. different colors) in a prearranged manner so as to produce a mosaic with geometrical shapes or patterns.

Moreover, several panels may be used to compose a single mosaic, in order to create a mosaic with a pattern of any size, or a repetitive pattern, depending on the surface area on which it is to be applied.

The main advantage of the machine and method according to the present invention lies in that it is extremely versatile, because it enables containment panels to be filled with tiles presenting different characteristics (i.e. colors or other features) in a previously-established arrangement so as to develop a mosaic with geometrical shapes or patterns.

Moreover, the set-up of the machine can be modified by means of the software, i.e. without the need for any manual operations on the mechanics of the machine, to change the type of mosaic to produce. The pattern on the mosaic can consequently be changed in a very straightforward and cost-effective manner, without the need to take any complex action on the machine. This means a considerable saving in the panel production costs and times, both to create a single mosaic for applying to a wall and to prepare different mosaics for different customers.

Moreover, a plurality of functions or additional operations can be added to make the process even more straightforward. For instance, provision can be made to enable the distribution of the colors or the layout of the pattern of the mosaic to be modified before filling the panels simply by changing the simulation; or reference numbers can be automatically printed for each panel, which would be very useful in facilitating the subsequent installation of the whole mosaic; or, again, a general photograph could be printed showing the arrangement of the pattern on the various panels and tiles; and so on.

Another advantage is that high productivity rates can be achieved using the machine according to the invention, since the procedure has a high degree of automation, with the opportunity to conduct intermediate checks and verify the end result before the machine is started.

The panel filling speed can be substantially increased, in some embodiments reaching an estimated productivity of approximately 10 panels per minute (for panels of approximately 150-200 tiles each). It is worth noting that a semiautomatic system involving the use of an articulated arm for selectively inserting one colored tile at a time in a containment panel of approximately 150-200 tiles takes more than 5 minutes to fill a whole panel (without any automated verification phases).

Yet another advantage of some embodiments of the invention derives from the fact that very compact and easily moved or transported modular units can be used in the construction of a machine of this type, which facilitates the addition of further units and the optimization of the space available for the construction of the machine.

Moreover, a mosaic of any dimensions can be obtained with both a high level of customization and a good quality, because the tile positioning errors are reduced to a minimum.

Further advantageous characteristics and embodiments of the method and of the device according to the invention are described in the attached dependent claims and are further explained below with reference to some non-limiting embodiments.

### BRIEF DESCRIPTION OF THE DRAWINGS

The present invention can be more readily understood and its numerous objects and advantages will become more clear to a person skilled in the art by referring to the attached schematic drawings showing a non-limiting practical example of the invention. In the drawings:

FIG. 1 shows an axonometric view of a working unit according to an embodiment of the invention without a panel of tiles;

FIG. 2 shows a panel for mosaic tiles for use in the machine according to the invention;

FIG. 3 shows a view taken along line II-II of FIG. 1 with a panel of tiles installed;

FIG. 4 shows a view taken along line III-III of FIG. 3;

FIG. 5 shows a machine comprising the working unit of the previous figures according to an embodiment of the invention;

FIG. 6 shows a machine for filling panels with tiles according to an embodiment of the invention;

FIG. 7 schematically shows part of a finished mosaic obtained with panels of tiles according to the invention;

FIGS. 8A and 8B show a prospect view of a working unit according to another embodiment of the invention in two different phases of work;

FIG. 9 shows a lateral view in partial section of the machine of FIG. 8A;

FIG. 10 shows a prospect view of a detail of the machine of FIG. 8A, 8B;

FIG. 11 shows a further prospect view of another detail of the machine of FIG. 8A, 8B;

FIG. 12 shows a partial view taken along line XII of FIG. 11;

FIGS. 13, 14, 15 and 16 show a detail of the machine of FIG. 8-12 during different steps of the processing cycle;

FIG. 17 shows a schematic drawing which can be reproduced in the form of a mosaic by arranging side by side panels of tesserae or tiles assembled with a machine according to the invention; and

FIGS. 18 and 19 show a perspective view and a plan view of a device or machine according to a further embodiment of the invention.

### DETAILED DESCRIPTION OF EMBODIMENTS OF THE INVENTION

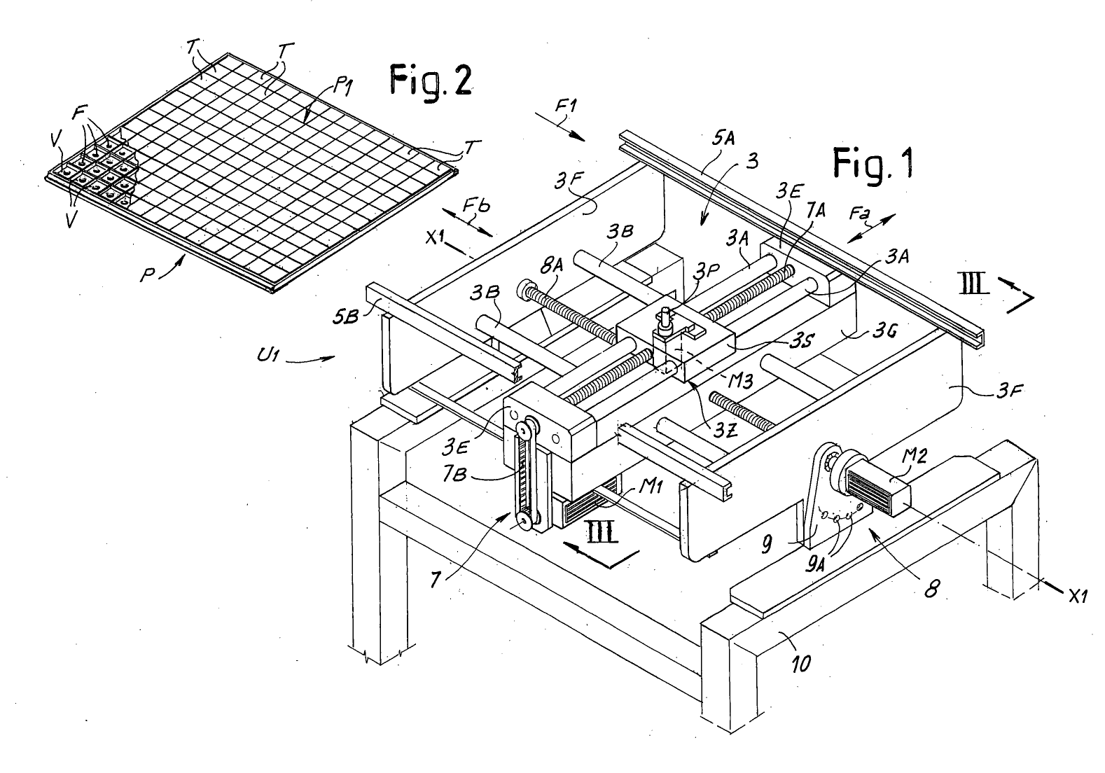

In the drawings, where the same numbers are used to indicate the same parts in all the different figures, a machine for filling containment panels P with previously-selected tiles T according to the invention—see FIG. 1—comprises a remover unit U1 using a Cartesian robot 3 controlling the motion of a remover system 3Z. In some embodiments the remover system 3Z includes a carriage or supporting frame 3S slidingly movable along a first pair of guides 3A extending orthogonal to the panel advancement direction F1 supported by a second carriage 3G, which in turn is slidingly guided along a second pair of guides 3A and 3B lying perpendicular to the direction of advancement F1 of the panels P.

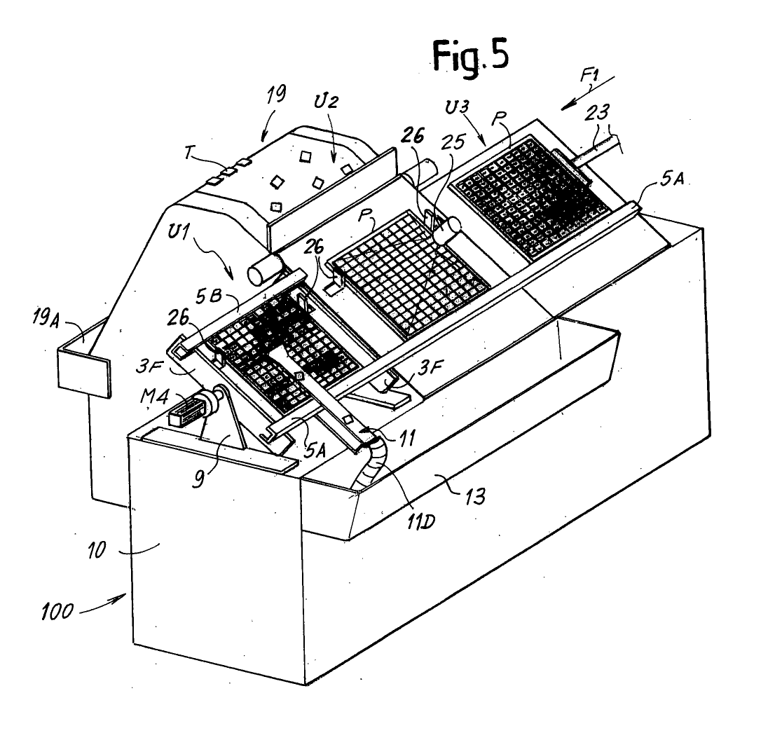

In an advantageous embodiment, shown in FIG. 1, the guides 3A and 3B are formed by respective pairs of cylinders fixed at the ends to first and respectively second supporting elements 3E and 3F. The remover system 3Z slides in a first direction Fa along the pair of guides 3A together with the first supporting element 3E, and in a second direction Fb along the pair of guides 3B. The second supporting element 3F is attached to a frame 10 and revolves around an axis of rotation X1 of a bearing 9, see also FIG. 3.

Preferably on the second supporting element 3F sliding rails 5A and 5B are provided, which define a plane for the sliding of the panel P above the remover system 3Z in a forward feed direction F1. In this case, the direction F1 lies parallel both to the second sliding direction Fb of the remover system 3Z and to the rotation axis X1 of the second supporting element 3F.

In the embodiment described herein, the remover system 3Z is advantageously driven along the pair of guide cylinders 3A by a worm screw transfer system 7 comprising a first motor M1 attached to the first base 3E and connected by means of a first toothed belt 7B to a first worm screw 7A associated revolvingly on the first frame 3E and lying parallel to and in between the guides 3A; the sliding of the remover system 3Z along the guides 3A is thus controlled by the rotation of the first worm screw 7A driven by the first motor M1.

Another worm screw transfer system 8 serves to move the remover system 3Z along the guides 3B independently of the movement along the guides 3A. In a manner similar to the transfer system 7, this transfer system 8 comprises a second motor M2—shown in FIG. 1—attached to the second base 3F and mechanically connected to a second worm screw 8A by means of a second toothed belt 8B. The second worm screw 8A is associated with the second frame 3B and lies parallel to and between the guides 3B so as to make the remover system 3Z slide along said guides 3B by means of the rotation of the second worm screw 8A driven by the second motor M2.

Clearly, the above-mentioned remover system 3Z based on the Cartesian robot concept is described merely as an example, since any other embodiment suited to the purpose may be used, such as an articulated mechanical arm (instead of the guides 3A and 3B, with which the remover system 3Z is associated) or other embodiments.

Moreover, the Cartesian robot 3 may comprise different devices or systems based on the needs of construction and/or usage, e.g. the sliding guides 3A and 3B, and the drive systems 7 and 8 may be of a different type.

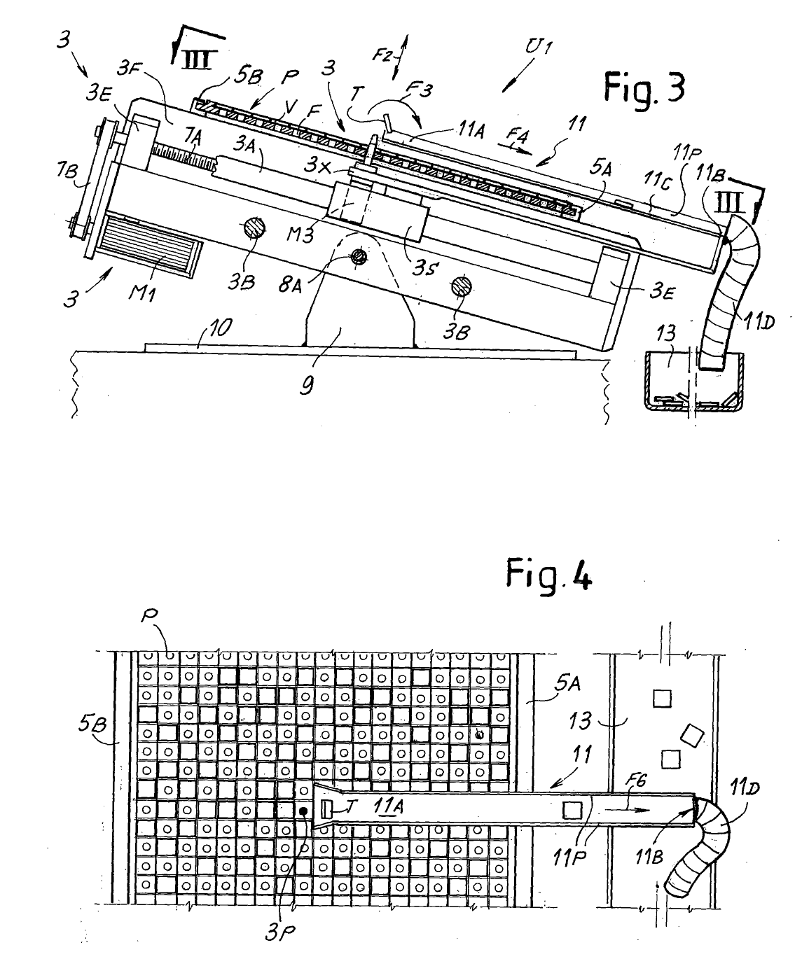

In an advantageous embodiment the remover system 3Z is comprised of the above mentioned supporting frame 3S that engages with the worm screws 7A and BA and comprises a remover element 3P in the form of a vertically movable stud 3P suitable for inserting in a through hole F provided in each seat or cavity V in the panel P (see FIG. 2), so that it comes to bear on each tile T to eject, i.e. remove. The remover element 3P is controlled by an actuator M3 associated with the supporting frame 3S of the remover system 3Z.

Clearly, said remover system 3Z can consist of any other device or system to suit particular needs of construction or usage; for instance, it may consist of a nozzle for injecting compressed air through each hole F in the panel P to exert a pressure on the tile T to eject, or it may consist of at least one sucker designed to retain at least one tile, or yet other solutions.

The Cartesian robot 3 operating the remover system 3Z is arranged above the panel P if said remover system 3Z consists of a sucker.

FIG. 2 shows the panel P in an embodiment particularly suitable for use with the present invention, in which it should be noted in particular that the panel P comprises a side P1 for containing the tiles T in the shape of a grid with a mesh defining seats V with raised edges for containing one tile T each. The panel P in the shape of a grid advantageously includes a through hole F in each seat V to enable the remover system 3Z to take effect on each tile T to remove.

FIG. 3 shows the remover unit U1 and, in particular, the remover system 3Z and the panel P tilted with respect to the horizontal at an angle sufficient to enable the tiles T to be ejected from the panel P. In a particularly straightforward and effective embodiment of the invention, this tilting angle can be adjusted by an operator by manually rotating the second supporting element 3F around the axis of rotation X1, then locking it in place with a pin (not shown in the figure), which can be inserted in one of the locking holes 9F provided on the bearing 9. In the embodiment described herein, said axis X1 lies in an approximately central position with respect to the supporting element 3F and parallel to the forward feed direction F1 of the panel P.

Clearly, the tilting angle of the remover system 3Z may also be adjusted by any other manual or motorized means or system.

FIG. 3 also shows a recovery system 11 for recovering a tile T when it is ejected from the panel P that preferably comprises a sliding channel 11C with a first flared and substantially blade-shaped end 11A suitable for holding the tile T when it is ejected from the panel P and an opposite open and curved second end 11B so as to unload the tile T by dropping it into a container 13 below and connected to the remover system 3Z passing underneath the panel P. The sliding channel 11 thus moves integrally with the remover system 3Z and its blade-shaped end 11A follows closely behind the remover element 3P of the remover system 3Z.

In particular, the panel P is tilted with respect to the horizontal (by its rotation around the axis X1) so that the remover element 3P of the system 3Z moves along a removal direction F2 that is inclined with respect to the vertical when it removes a tile T. The blade-shaped end 11A occupies a position such that when a tile T is ejected from its seat V, it drops onto the blade by gravity (see arrow F3).

As soon as the tile T drops onto the blade 11A it slides (see arrow F4) along the tilted sliding channel 11 until it reaches the end 11B, from where it drops into the container 13. A flexible hose 11D can be provided to facilitate the fall of the tile T into the container 13.

The above-described channel recovery system 11 is particularly straightforward, economical and effective, but the recovery system can clearly be differently designed to serve the same purpose. For instance, it may comprise a motorized suction element that follows the remover element 3P of the system 3Z to suck the tile T as soon as it is ejected. In this latter case, if the suction power is suitably adjusted, it may not be necessary for the panel P to be in a tilted position.

Moreover, the recovery system 11 becomes unnecessary in the case of the remover system 3Z involving a remover element of the type based on suckers or similar devices.

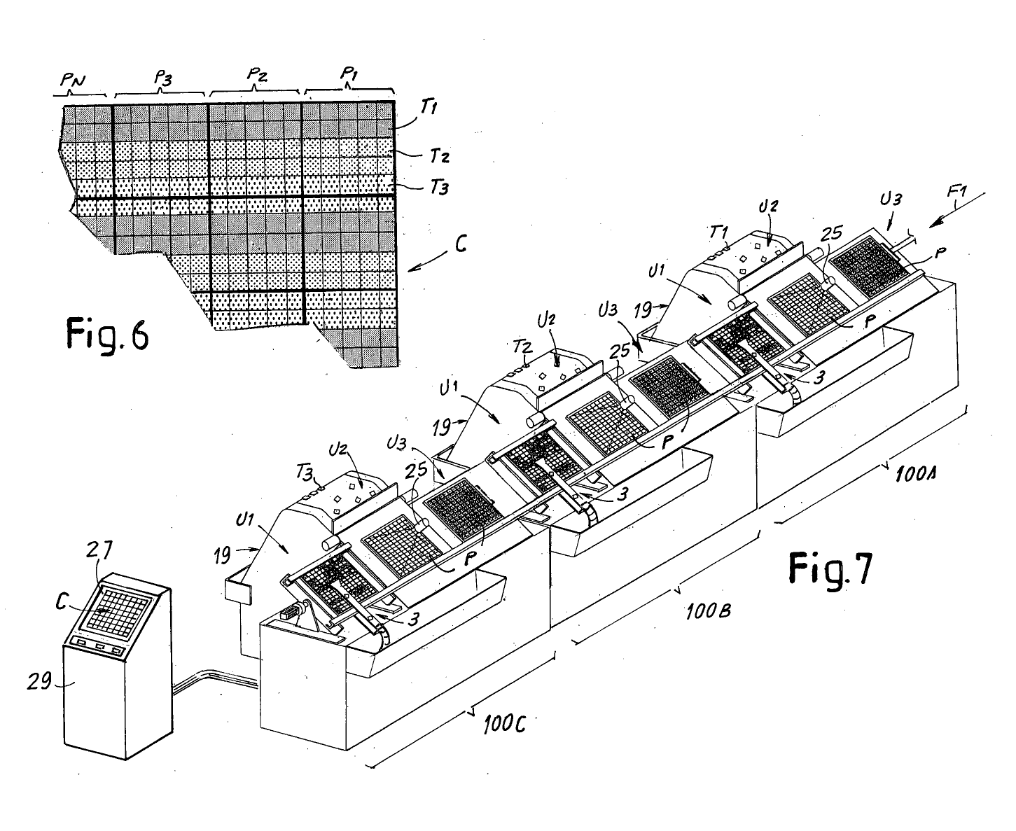

FIG. 4 shows a view from above along line III-III, particularly showing that the channel 11 has side walls 11P to prevent the tile T from dropping back onto the panel P before it reaches the end 11B.

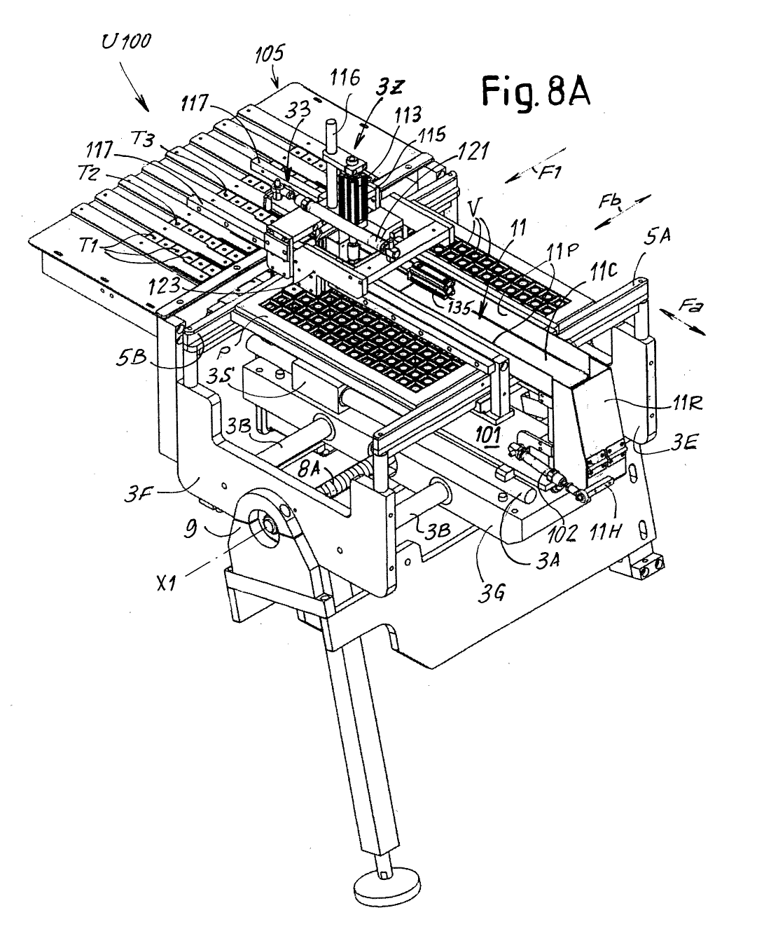

FIG. 5 shows a module 100 forming a part of a machine for selectively filling a plurality of panels P, comprising the above-mentioned unit U1 and also comprising a unit U2 for filling and orienting the panels P and an initial forward feed unit U3.

Said units U1, U2 and U3 are preferably associated side by side on a frame 10 so as to follow the same continuous forward feed direction F1 along which a panel P proceeds, driven by a drive system 23, schematically represented in the figure by a telescopic pusher; clearly, said drive system 23 may be of any other type suited to the purpose, such as a toothed pusher or the like.

Moreover, this does not rule out the possibility of a different single unit (not shown in the figure for the sake of simplicity) comprising a combination of at least two (or all three) of the above-mentioned units U1, U2 and/or U3, in order to make the module 100 more compact.

The filling and orienting unit U2 of the module 100 is preferably suitable for gradually filling the panel P with a set of tiles T of the same color, or other previously-selectable characteristic (e.g. the shape or size of the tiles, or other features) and can be of a substantially known type.

FIG. 5 schematically shows this unit U2 with a hopper 19 that collects the tiles T from the tank 19A and positions them with their exposed surface facing upwards by means of an orientation system (not shown in the figure, that may be of a substantially known type, such as a suction system or an optical system, a negative pressure system, or the like), in order to deliver the tiles to the panel P. The tiles can be distributed over the containment surface P1 by making the panel P vibrate.

The filling and orienting unit U2 is advantageously associated with a viewing system 25 for identifying any tiles T of a given color (or other given characteristic) occupying seats V other than as required in the panel P.

Finally, a gripping system 26 is arranged on both the filling unit U2 and the unit U1 to hold the panel P firmly during the process.

Said gripping system 26 is schematically shown as a pair of pawl members on the sliding plane that open in opposition to the panel P in order to hold it in position. The opening and closing of these pawl members 26 can be controlled automatically. Clearly, said gripping system 26 is described merely as an example, since it may be achieved with any other means, system or device suited to the purpose.

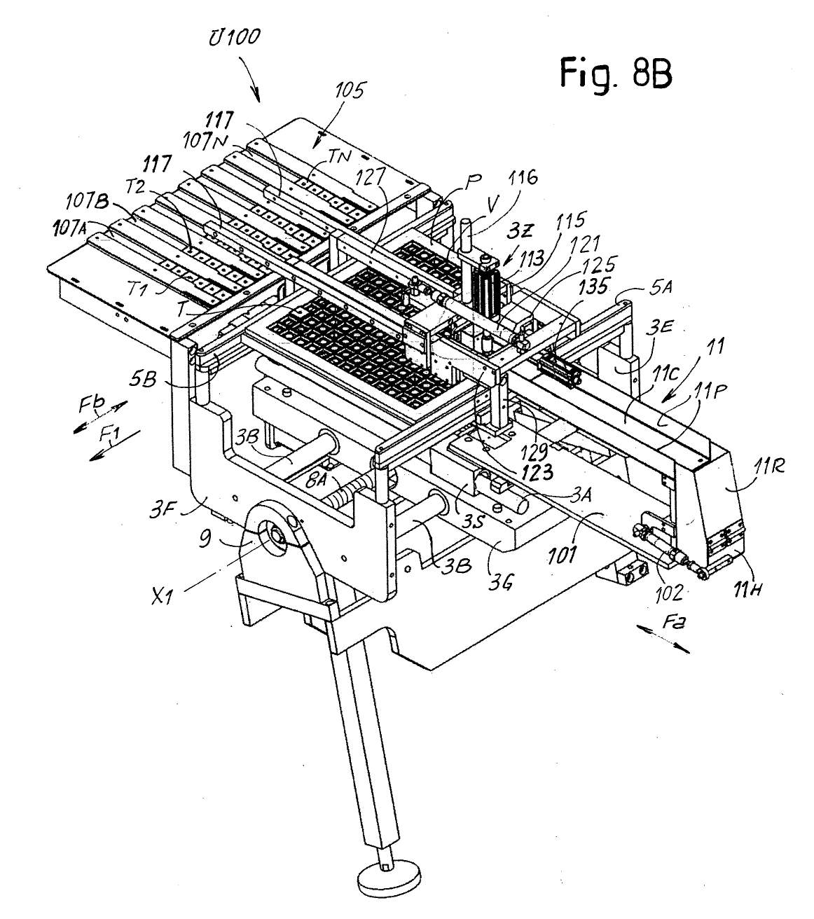

FIG. 6 shows an example of a mosaic C in three colors, which can be obtained using a machine according to the invention and which includes a plurality of panels P1, P2, P3, Pn. A first set of tiles T1 of a first color, a second set of tiles T2 of a second color and a third set of tiles T3 of a third color are placed in said panels in previously-selected positions so as to form the required colored geometrical pattern. In this case, the pattern consists of three colored strips obtained with the tiles T1, T2 and T3, but may be any other geometrical shape or pattern.

The number “n” of panels P1, P2, P3, Pn depends mainly on the size of the wall to cover with the mosaic C and can even largely vary even enormously from one application to another. The size of each panel P1, P2, P3, Pn and the size of the tiles T1, T2 and T3 and their number in each panel can likewise be decided case by case as a function of the specific application.

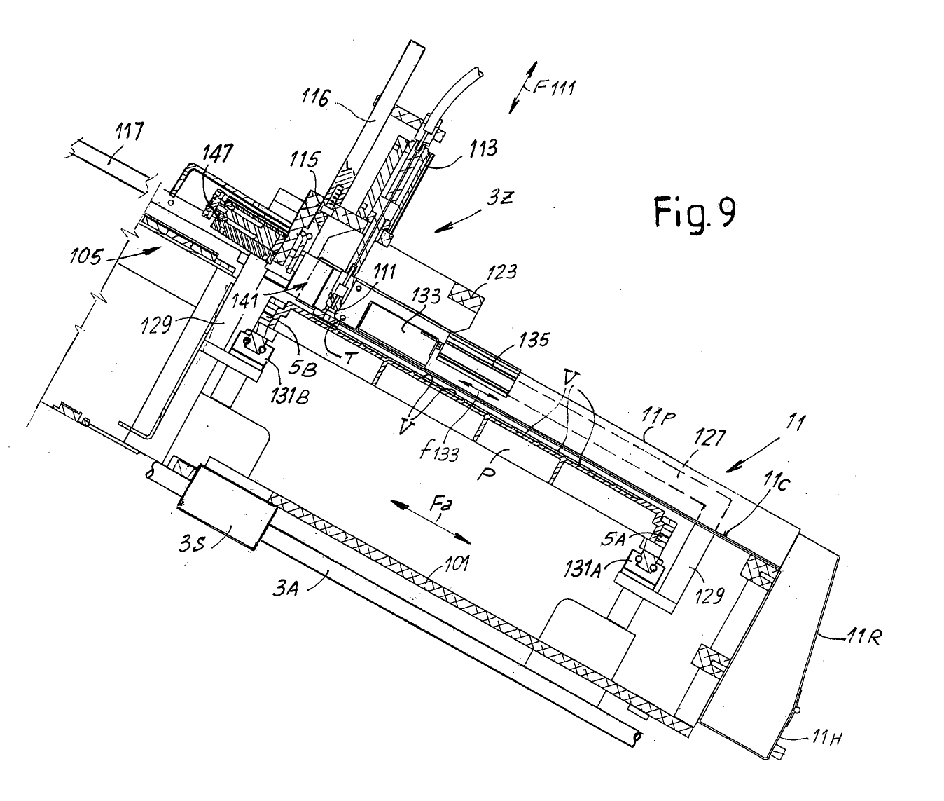

FIG. 7 shows a configuration of a machine for selectively filling a plurality of panels P comprising three modules 100A, 100B and 100C arranged side by side.

Each of said three modules 100A to 100C advantageously comprises an unit U1, a filling and orienting unit U2 and a forward feed unit U3, side by side and in a line, so that each module 100A to 100C sequentially fills one of the panels P with a set of tiles T1, T2 and T3.

Each forward feed unit U3 preferably comprises the above-mentioned drive system 23 to make the panel P in each module 100A to 100C advance along the sliding direction F1.

In an alternative embodiment, there may be a different combination of said units U1, U2 and U3 on each module 100A, 100B and 100C to suit particular structural needs. For instance, a forward feed unit U3 may be provided only on the first (100) of the modules 100A to 100C, in which case the drive system 23 for the panel P may be of a different type, adapted to the configuration of the machine.

It is emphasized that this does not rule out the possibility of each set of tiles T1, T2 and T3 comprising tiles of two or more colors, or of only one color in different shades (or other characteristics) in order to contain the number of modules 100A to 100C used in the machine and to further increase the panel filling rate.

Moreover, the preferred embodiment of the present invention (see FIG. 7) involves a central processing and control system 27 that is used to produce an electronic simulation of the mosaic C (see FIG. 6), creating an image or a drawing divided into a plurality of panels P1, P2, P3, Pn and of tiles T1, T2, T3. The central system 27 is also used to view said simulation on a screen 29 and to control the filling machine units U1, U2 and U3.

In particular, the central system 27 is advantageously designed to compare the simulation of the mosaic C with the real position of a set of tiles in each of the panels P1-Pn being processed by means of each of the viewing systems 25, so as to identify the position of any tiles that need to be removed and send this information to the remover system 3Z as described in more detail.

Clearly, the central system 27 can include of a single central system, as described herein, or a series of at least partially separate processing and control systems, or other solutions, depending on particular structural needs and usage.

Basically, the method for operating the machine according to the invention advantageously comprises at least one initial phase, in which the mosaic C is simulated electronically, and subsequent filling phases that include randomly filling the panels P, P1, P2, P3 and Pn with respective sets of tiles T, T1, T2 and T3; then checking the real position of each of the tiles T, T1-T3 in each panel P, P1-Pn comparing the simulation with said real positions by means of the respective viewing system 25, so as to identify any tiles T1-T3 that need to be removed; then ejecting these tiles, if needed, by means of the remover system 3Z.

In a possible embodiment, the customer requiring the installation of the mosaic C may provide an image of the pattern to achieve with the mosaic C in the form of a photograph or an image-format file, which is transferred by means of a scanner or in electronic format to the central system 27.

The central system 27 analyses the colors in the image produced and advantageously converts the colors in the image into the most similar colors available in a database previously acquired by the central system 27.

Alternatively, the central system 27 may acquire the range of colors in the image and save them directly in the color database so as to obtain colors that resemble as faithfully as possible the colors in the image to be reproduced with the mosaic C.

In this latter case, it should be noted that in order to obtain colors resembling those of the image as faithfully as possible, it is preferable to use an image acquisition system that acquires the colors by means of a dedicated offline color viewing system for the self-learning of the real colors and the available shades. This does not necessarily rule out the possibility of using the previously-mentioned color selection database to simplify the machine.

After establishing the dimensions of the mosaic C, of the panel P, of the tiles T1-T3, and of the joint gaps (i.e. the spaces) between the tiles T1-T3 and between the various panels P as installed on the wall, the central system 27 divides the image into a plurality of panels P, and then into a plurality of tiles T1-T3 depending on the previously-defined dimensions, so that each tile T1-T3 corresponds to a given color from the available range.

The central system 27 can thus reconstruct a simulation on the screen 29 of the mosaic C that will be created on the panels P with the tiles T1-T3, based on the available colors, enabling a visual check on the end result before starting the filling machine.

If the image reconstructed on the screen does not present the required characteristics, the colored tiles T1-T3 can be manually rearranged on the panel P or the image on the screen can be modified manually. In this latter case, the image generating system can generate a new image.

The color of individual tiles T1-T3 can also be changed in order to modify the distribution of the colors or the pattern reproduced on the mosaic C.

According to a particularly advantageous embodiment, once the simulation of the mosaic C distributed on the panels P with the tiles T1-T3 has been checked and approved, the central system 27 processes the production of the panels P, associating a sequential number with each panel P and thereby enabling the sequential numbering to be printed on the protective and supporting film subsequently applied to each panel P by means of an in-line labeling machine, thus greatly facilitating the installation of the panels P on the wall to create the mosaic C. It is also possible to print a final image of the mosaic C divided into sequentially-numbered panels P of tiles T1-T3.

The system can subsequently prepare a production sheet indicating the customer's code, the approved images and/or photographs, the number of panels P, and the sets of tiles T1-T3 to place in each panel P, arranged in order of decreasing quantity. More precisely, the first module in the machine can fill a panel with the set of tiles T1 that is most numerous, while the subsequent modules can complete the panel with the sets of tiles T2 and T3 in declining order of the quantities needed of said tiles. This will mean that only the minimum number of tiles will need to be ejected from each module or panel, further reducing the time it takes for the machine to completely fill a panel.

The above described filling phase is advantageously implemented using the above-described machine and involves the following steps being completed sequentially by each module 100A to 100C (see in particular FIG. 6):
random filling of the panel P with tiles of a first color T1 by the filling unit U2 on the first module 100A;
checking by the viewing system 25 on the first module 100A to ensure that the panel P being processed has been filled at least in the seats V that should be occupied by the tiles T1, stopping the delivery of the tiles T1 as soon as the viewing system 25 confirms said filling;
identifying any tiles T1 in seats V other than as required for the first color by means of the viewing system 25, which sends the coordinates relating to the seats V where there are unwanted tiles T1 to the unit U1 of the module 100A;
removing any tiles T1 from the seats V where those of the first color are not required in the panel P by means of the remover system 3Z of the unit U1;
checking that there are tiles T1 contained in the seats V as required and that the remaining seats V contain no unwanted tiles T1.

If this last check determines that tiles T1 are contained in seats V other than as required, the step for removing these unwanted tiles T1 is repeated. If some of the seats V have not been filled with tiles T1 as required, more tiles T1 of the first color are delivered onto the panel P in order to fill the seats V that are still empty, subsequently removing any tiles T1 from seats V where they are not wanted.

If the result of the check is positive, i.e. if tiles T1 are found only occupying the seats V where they are required, then the panel P is transferred to the next module 100B, where the same panel P is filled with tiles T2 of a second color by means of a series of operations substantially similar to those described previously.

In particular, after the filling unit U2 of the second module 100B has delivered the tiles T2 of the second color onto the panel P (which now has some of its seats V already filled with tiles T1), a check is conducted by the viewing system 25 of the second module 100B to ensure that the panel P has at least been filled in the seats V required with tiles T2. Then the viewing system 25 of the second module 100B checks to ensure that there are tiles T2 occupying the seats V in the panel P as required, and to identify any tiles T2 occupying seats V where the second color is not required. Then the remover unit U1 of the second module 100B removes any tiles T2 from seats V not destined to contain the second color. A final check is subsequently performed to ensure that there are tiles T2 only in the cavities V where they are required, and the filling and/or removal steps are repeated in the event of a negative outcome (as explained previously).

These steps for filling a panel P with tiles of different colors are repeated sequentially, depending on the number of colors required, by the respective modules 100A to 100C, until the pattern has been completed with the tiles T1-T3 in a panel P.

Each module 100A to 100C thus serves to fill seats V in one of the panels P with a set of tiles T1-T3 of at least one given color. This does not rule out the possibility of having a set of tiles T1-T3 consisting of tiles of two or more colors, or of different shades of a color, to make the filling action faster and reduce the number of modules 100A to 100C in the machine.

In a particularly advantageous embodiment of the invention, a final module can be provided, including a unit similar to the recovery unit U1 and also comprising a gripping arm movable integrally with the blade 11A (and possibly associated with the same channel 11) suitable for grasping at least one tile by means of a gripping member, such as a sucker or similar means. Said gripping arm can thus pick up any tiles that need to be removed and release it into the container 13 below, or onto said blade 11, or even into suitable side containers (possibly divided according to the color of each set of tiles T1-T3).

If any tiles are upside down, suitable side containers can advantageously be used that comprise a helically shaped inlet, through which the tile can slide and be gradually overturned, so that said tile can automatically be stored in the side container with its colored side suitably positioned (facing upwards).

The viewing system of the above-mentioned final module is advantageously and preferably suitable for checking the real colors or shades obtained by means of the colored tiles T1-T3 in the completely filled panel.

In this last case, the TV camera of the viewing system can advantageously have a resolution (e.g. from approximately 640×480 pixels to approximately 1600×1600 pixels or more) optimized for viewing the whole panel and checking the colors of each tile at the same time.

This final module is preferably associated with a machine according to the invention, but this does not rule out the possibility of it being associated with filling machines of a different type. Moreover, there may be a particularly compact final module including two or more units U1, U2 and U3.

The panels P may be of any type, size and shape. For instance, the panels may be 350×350 mm or 400×400 mm, or any other size. The tiles T1-T3 may also be of any type, shape or size. For instance, they may be approximately 10×10 mm or 25×25 mm, or any other size.

The error in the positioning of the tiles T1-T3 is estimated to be approximately 3 mm, while there may be any number of colors in the image, depending on the pattern to reproduce in the mosaic. For instance, there may be patterns that involve 8 or more colors.

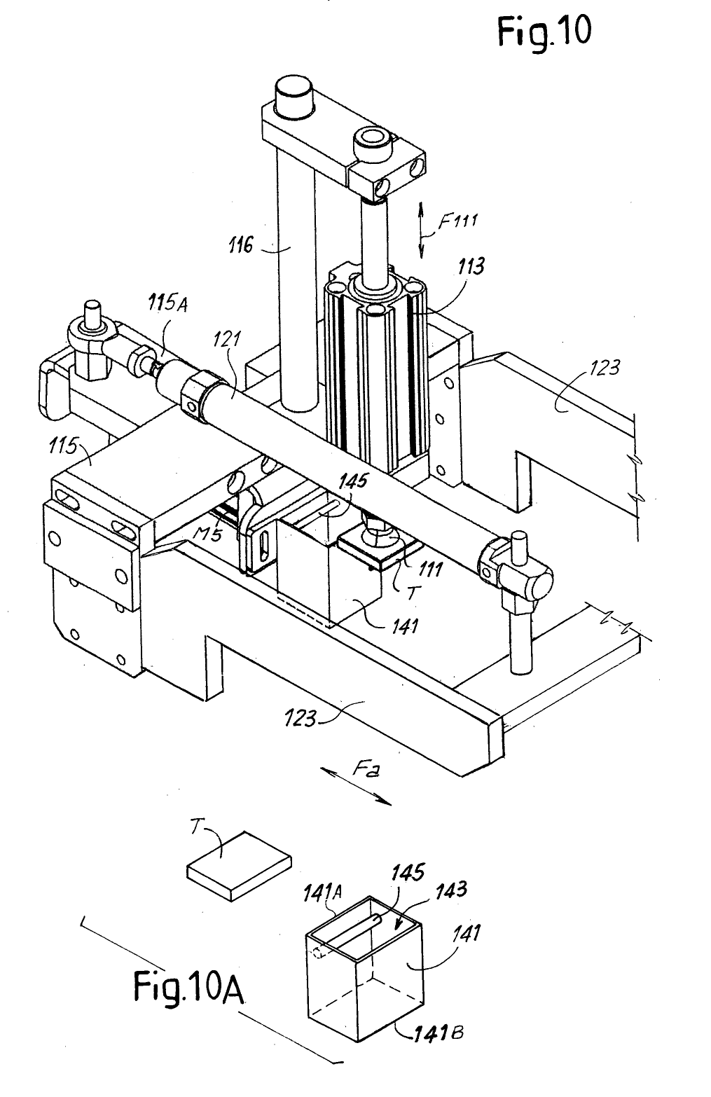

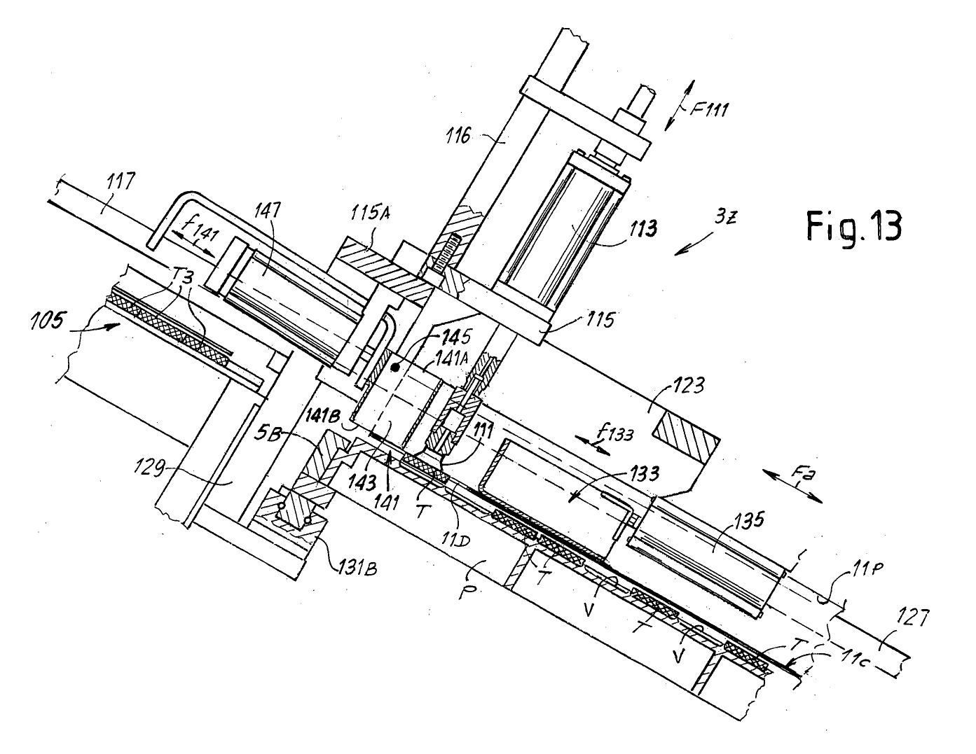

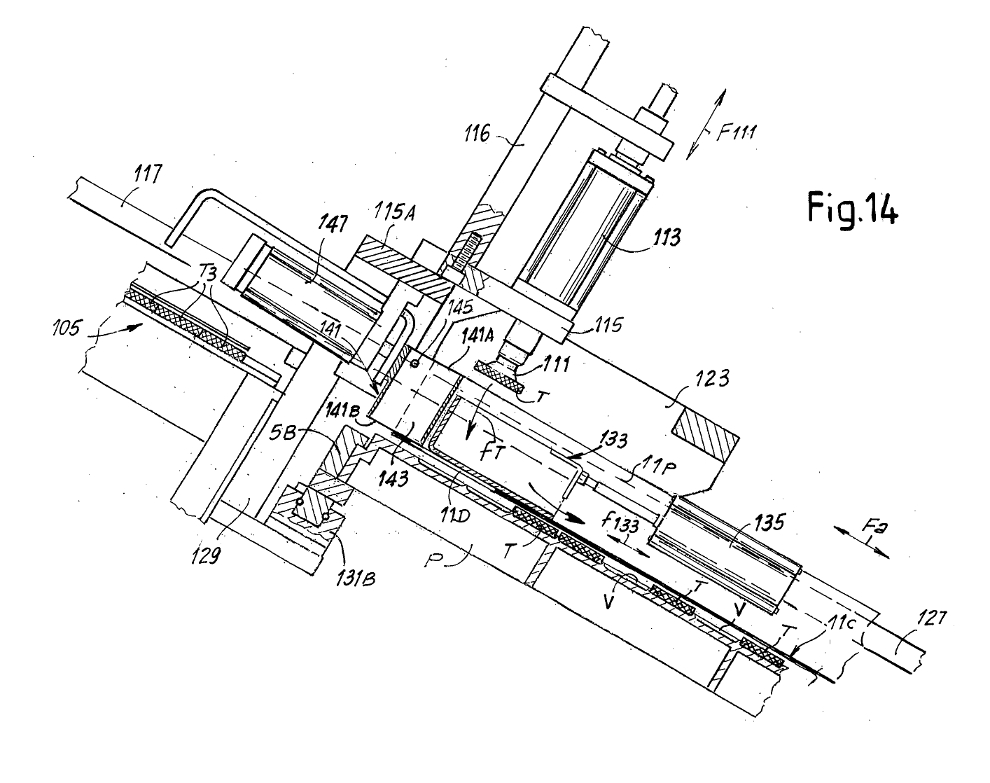

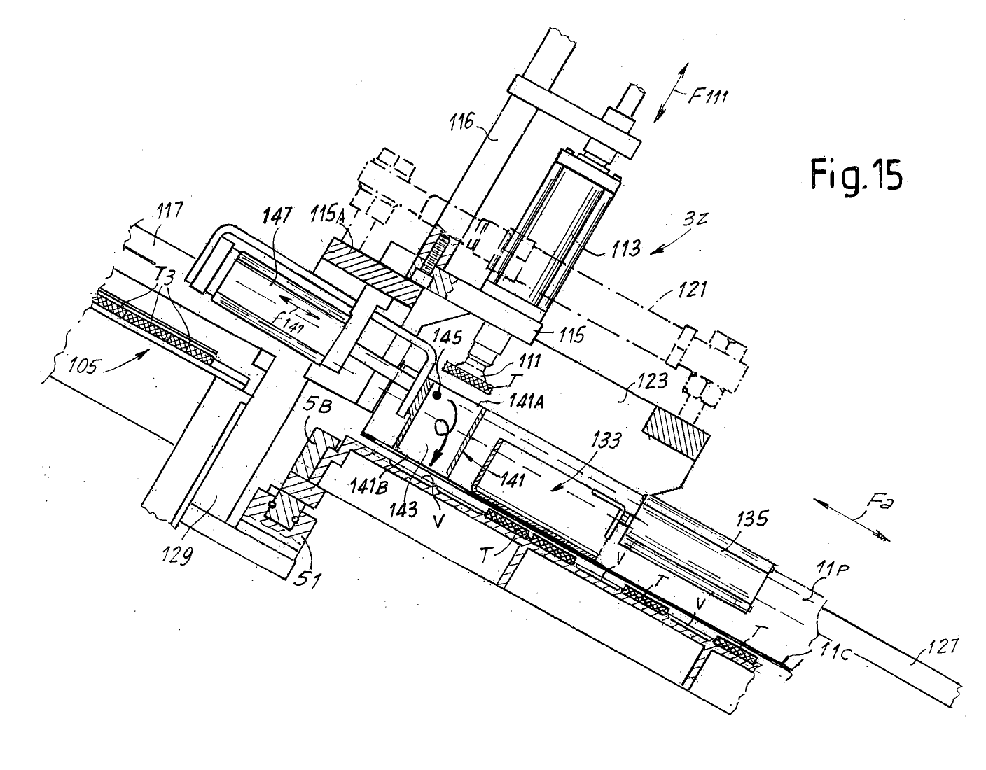

FIGS. 8A to 16 show a different embodiment of the invention. In this embodiment elements corresponding or equivalent to those described above with reference to FIGS. 1 to 7 are indicated with the same reference numbers. More specifically, FIGS. 8A and 8B show a unit U100, which performs functions similar to those of unit U1, but which also carries out additional functions in order to fill the tiles or tesserae in the panel according to a pre-establish arrangement or pattern. Reference number 3Z indicates a remover system which is able to individually remove tiles T from the individual seats V of the panel P, which is arranged in the unit U100. As will be clear from the following description the remover system 3Z has additional functions besides those of the remover system 3Z disclosed in the previous example.

The movement of the remover system 3Z is controlled along directions Fb and Fa by means of a Cartesian robot or other control system similar to the one disclosed above. More specifically the moving or control system includes a pair of guides 3A arranged on a carriage 3G and extending along direction Fa orthogonal to the machine direction, i.e. the direction F1 along which the panels P advance through the machine. The carriage 3G moves along guides 3B extending parallel to the machine direction F1 and supported by the frame 3F. Reference number 8A indicates a threaded bar controlling the motion of carriage 3G, while the carriage or supporting frame 3S is moved by a similar threaded bar, not shown. Both threaded bars are rotated by respective step motors or other electronically controllable actuators.

A plate 101 is rigidly connected to the supporting frame 3S and moves along directions Fb and Fa under the control of the Cartesian robot described above. On plate 101 a recovery system 11 is supported. Said recovery system 11 includes a sliding channel 11C, provided with a bottom surface, along which tiles T removed by the remover system 3Z slide by gravity to be collected in a collection reservoir 11R arranged at the lower end of the sliding channel 11C. The sliding channel 11C is provided with side walls 11P which prevent the tiles from falling down. The reservoir 11R is closed at the bottom by a closure 11H controlled by a cylinder-piston actuator 102 or the like. In this manner the tiles which are discharged along the channel 11C collect in the reservoir 11R irrespective of the position of the channel 11C and can be then recovered in a collecting tray or the like arranged in a side position, not shown, where the recovery system 11 can be parked.

As can be seen from FIGS. 8A and 8B, the remover system 3Z (performing, among others, also the function of ejecting i.e. removing the tiles from the seats V in the panel P) is arranged above the plane along which said panels P are caused to advance, differently from the previously shown example, where the remover system 3Z is arranged underneath said plane.

The advancement plane is defined by a pair of parallel guides 5A and 5B, which are rigidly supported on a frame formed by supporting elements 3E and 3F, connected by guides 3B. Said frame 3E, 3F, 3B is adjusted in a tilted position around an axis X1 in a manner similar to that disclosed in connection with the previous embodiment.

With the above arrangement the remover system 3Z can be moved along directions Fa and Fb to take any position along the entire development of panel P.

On a side of the plane of advancement for the panels P a storage device 105 is provided. In some embodiments the storage device 105 is provided with a plurality of channels 107A 107B . . . 107N, each of which can receive a set of tiles T1 T2 . . . TN. The sets of tiles T1-TN can differ from one another for example by color. Tiles stored in the storage device 105 can be used by the remover system 3Z to replace wrongly arranged or damaged tiles removed from the panel P in a manner which will be disclosed in more detail herein after.

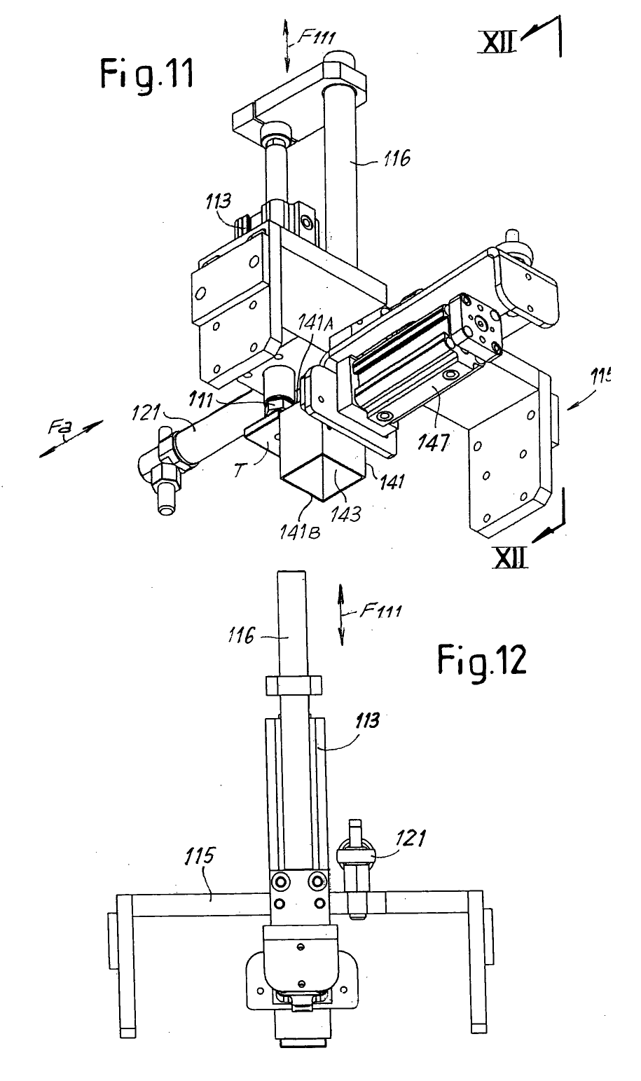

The structure and function of the remover system 3Z can be best understood from FIGS. 9 to 13. The remover system 3Z includes a remover element 111. In some embodiments, said remover element is in the shape of a sucker 111. The remover element 111 is movable according to double arrow F111 in a direction orthogonal to the plane of advancement of the panels P. An actuator 113, for example a cylinder-piston actuator, controls the motion according to double arrow F111.

In some embodiments, the cylinder-piston actuator 113 and the sucker 111 are supported by a frame 115, from which a post 116 extends, to which the cylinder-piston actuator 113 is connected. The frame 115 is provided with sliders, not shown, slidingly engaging a pair of guides 116, which extend parallel to the sliding channel 11C of the recovery system 11. Said guides 117 are placed above the advancement plane of the panels P and have such a length as to reach a position above the storage device 105 for the purposes, which will be explained later on. In this manner the frame 115 supporting the sucker 111 and its actuator 113 can be moved in the direction Fa beyond the position, which can be reach by the motion of the supporting frame or carriage 3S.

In some embodiments, this movement (which in actual fact represents an extra stroke of the sucker or remover element 111 with respect to the stroke performed by the supporting frame 3S) is controlled by a cylinder-piston actuator 121. One end of said cylinder-piston actuator 121 is connected to an extension 115A of the frame 115, while the opposite end is connected to a second frame 123, which is slidingly engaged by means of sliding blocks 125 to the two guides 117. Said additional frame 123 is in turn rigidly connected to the sliding channel 11C of the recovery system 11, such that the frame 123 moves integrally with said channel 11C following the movement of the plate 101 along the Cartesian axis defined by the guides 3A and 3B. Since the frame 123 is connected to the frame 115 by the cylinder piston actuator 121, also the frame 115 along with the remover element 111 and its actuator 113 can move along directions Fa and Fb together with the recovery system 11 and specifically with the sliding channel 11C.

The two guides 117 are rigidly connected to corresponding supporting members 127 extending parallel to the direction Fa and each of which is supported at both ends by posts 129. Each post 129 is provided with a respective slider 131A and 131B. The sliders 131A are slidingly engaged to the guide 5A in a position underneath the plane of advance of the panels P, while the sliders 131B are similarly engaged to the guide 5B. With this arrangement the supporting members 127 will follow the movement of the recovery system 11 and therefore of the remover system 3Z along the direction Fb but will remain stationary along the direction Fa while the recovery system 11 and the remover system 3Z move along said direction Fa.

In some embodiments, within the sliding channel 11C a collection box 133 is movably arranged. Said box 133 is movable in the direction of double arrow f133 under the control of an actuator 135, such as a cylinder-piston actuator, for the purposes that will be explained later on.

In some embodiments the box 133 can be replaced for example by a movable blade or by any other means, which can perform the same function as described here below.

The bottom of the sliding channel 11C is provided with an aperture or a slot 110 substantially corresponding to the position of the remover element or sucker 111. Said aperture allows the remover element 111 to reach the tiles T on the panel P arranged underneath the sliding channel 11C and to remove said tiles and/or to arrange tiles taken from the storage device 105 into empty seats V of said panel P. The purpose of the box 133 is to close the aperture 11D and to allow a tile T removed from its seat V by the remover element 111 to be discharged into the box and to slide therefrom along the sliding channel 11C to reach the reservoir 11R at the end of the channel 11C.

In addition to the box 133 or other similar member, the remover system 3Z also includes an overturning device 141, for turning the tiles T upside down if they are wrongly oriented in the seats V. In some embodiments the overturning device can include a box 141 with an upper aperture 141A and a lower aperture 141B. Between said apertures a passageway or path 143 is defined. Said path or passageway has a cross section having dimensions substantially corresponding to o slightly greater than the planar dimensions of the tiles T and a length between the upper and lower apertures 140A and 140B which is somewhat greater than twice the side of the tiles T which are usually square in shape.

In proximity of the upper aperture 141A a contrast element 145 is arranged in the passageway defined by the overturning device 140. In some embodiments said contrast element 145 can include a bar, a pair of pins, a wire or any other suitable element which extend preferably in a direction parallel to Fb. In some embodiments the contrast element 145 is arranged close to that edge of the upper aperture 141A, which is nearer to the storage unit 105, i.e. the higher edge. The box 141 can move along the direction represented by arrow f141 under the control of an actuator 147, e.g. a cylinder-piston actuator. The cylinder-piston actuator 147 is supported by the frame 115 such that the box 141 can move with respect to said frame and can be placed in alignment with the trajectory of the remover element 111, i.e. above the aperture 11D in the bottom of the sliding channel 11C for the purposes, which will become clear from the following description.

The operation of the unit U100 described here above is the following. The mechanical members described above allow the remover system 3Z to perform substantially three different functions:
a) to remove broken, damaged or wrongly placed tiles T, for example tiles of a color, which have been place in a wrong seat V, where a tile of a different color had to be placed;
b) to overturn tiles T, which have been placed in the correct seat V but upside down, i.e. with the rear surface facing outside the seat V;
c) to introduce tiles in empty seats V and/or to replace wrongly placed or broken tiles with new tiles taking from the storage device 105.

All the above functions are performed in the following manner.

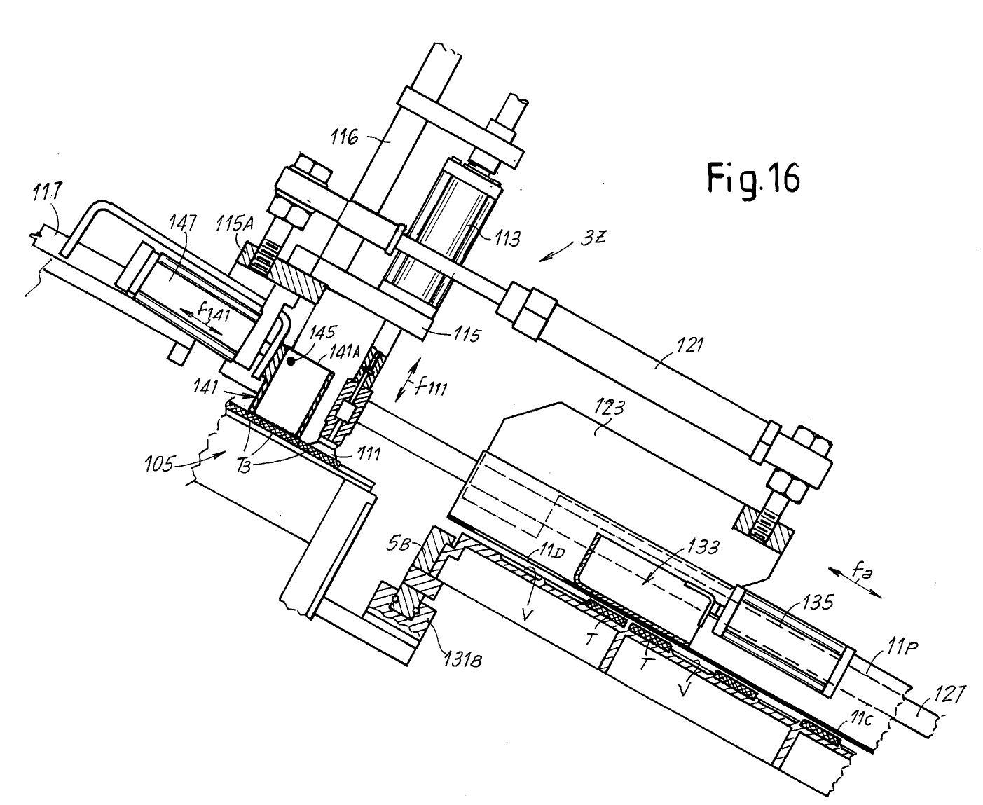

The remover element 111 is firstly placed at the seat V where one of the above mentioned operations have to be carried out. Wrongly placed tiles, broken or damaged tiles, or else tiles arranged upside down have been previously located by a vision system, such as a camera or the like, arranged in the unit U100, or else upstream thereof, in substantially the same manner as disclosed with reference to the previously described embodiment (see FIGS. 1 to 7). Positioning of the remover system 3Z is obtained by movements along Fa and Fb of the Cartesian robot using guides 3A and 3B and carriages or supporting frames 3S and 3G. In FIG. 13 an enlargement of the remover system 3Z is shown, in which the remover element 111 has just engaged a tile T, which has to be removed from the seat V in the panel P. If this tile has to be entirely removed, for example because it is broken or because it is of a color not corresponding to the one which should be located in that seat, the remover element 111 is lifted (arrow f111) until it reaches the position shown in FIG. 14. Subsequently, or during the last portion of the lifting movement of the remover element 111 the box or equivalent member 133 is moved (arrow f133 in FIG. 14) in order to close the aperture 11D and to be arranged substantially underneath the remover element 111. At this stage the suction, which has been activated and maintained to engage the tile T on the remover element 111, is deactivated and the tile T falls down (arrow fT) into the box 133 and in consequence thereof is discharged from a bottom aperture of the box into the channel 11C. By gravity the tile T reaches the collecting reservoir 11R at the back lower end of the channel 11C.

If the tile T, which has been removed from the seat V, is simply wrongly placed, i.e. is placed upside down, the remover system 3Z is able to place it again in the same seat in the reversed position. In order to perform this operation, once the remover element 111 has been lifted, or during the last part of the lifting stroke thereof, the box 141 is moved (arrow f141) in the position shown in FIG. 15. In this position the passageway 143 extending between the upper aperture 141A and the lower aperture 140B forms a sort of channel into which the tile T is discharged by deactivating suction in the remover element 111, such that said tile is released and again introduced into seat V from which it has been removed. Since the free falling down of the tile along the passageway 143 is prevented by the contrast element 145, said tile is obliged to perform a motion of upside-down reversal which is the result of the trajectory of tile T being altered by the contrast element 145. Surprisingly the tile T performs an entire revolution when after bumping against the contrast element 145, such that it falls in its seat in the correct position, i.e. upside down with respect to its original position.

If the tile T has been removed because it is broken or because it is for example of a color not matching a pre-determined pattern, the device is able to collect the correct tile, i.e. a new and no damaged tile or a tile of the correct color, from the storage device 105 and to place it in the empty seat V. Similarly, if a seat V is empty because of an error in operation of the units upstream of unit U100, the removal element 111 is moved above the storage 105 in order to pick up the correct tile and introduce it into the empty seat. In order for the remover element 111 to reach the tiles in the storage device 105, in some embodiments (as the one disclosed in the attached drawings) the remover element 111 performs an extra stroke taking the position shown in FIG. 16. As mentioned above, the extra stroke is controlled by actuator 121 and is obtained thanks to the fact that the frame 115 is guide by sliding blocks along the side guides 117.

Said guides 117 can move along direction Fb under the control of the Cartesian robot placed underneath the panel P, such that the remover element 111 can be brought in line with either one of the various channels 107A/107N, in which are stored tiles of different colors, or differing by any other feature.

An up and down movement (arrow f111) of the remover element 111 allows picking up the correct tile T and a reverse stroke controlled by the actuator 121, as well as a movement along Fa and Fb controlled by the Cartesian robot, brings the remover element 111 above the empty seat V where the newly picked up tile has to be placed. A lowering movement (arrow f111) of the remover element 111 brings the tile in the proper seat (FIG. 13).

The unit U100 disclosed above can be used alone or in combination with units of the kind disclosed in the previous embodiment. For example a unit U100 can be arranged as the last unit of a set of stations or units of a complex manufacturing line. In some embodiments several units U1, U2, U3, U100 can be placed in sequence to perform similar operations at various stages of the filling process. Unit U100 can also be arranged downstream of an existing manufacturing line.

It is important to note that unit U100 can perform a variety of operations in an entirely automated way, for example under the control of a programmable central control unit, to fill one or more panels with tiles or tesserae of different nature, for example different colors, according to a pre-stored or predetermined pattern or design. As mentioned above the pattern can be for example also a very complex drawing which shall be reproduced in the form of a mosaic by arranging side by side a larger number of tesserae previously preassembled into units, each unit including as many tesserae or tiles as there are in a single panel B.

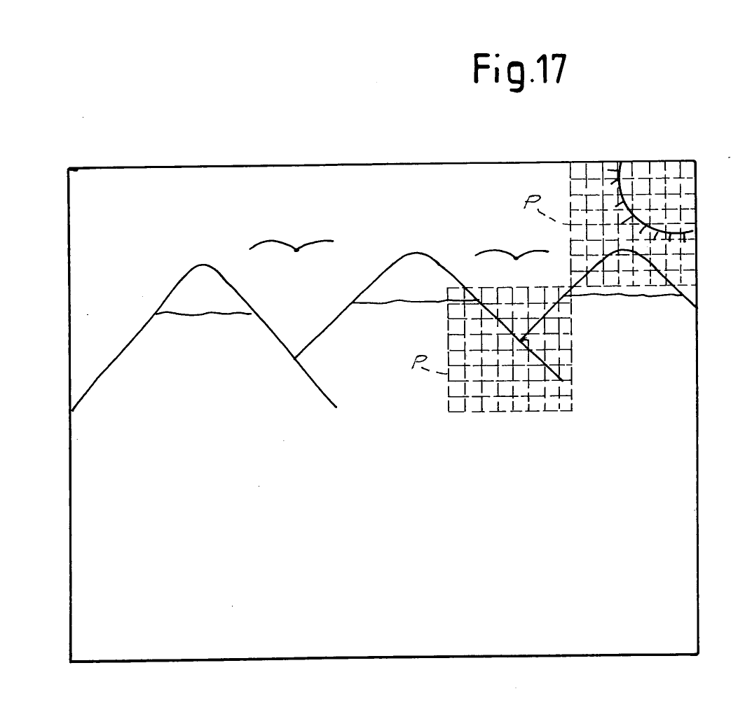

For a better understanding of the all process, which can be performed by one or more units according to the invention, reference shall be made to FIG. 17.

FIG. 17 shows a very schematic drawing, which one might desire to reproduce in the form of a mosaic. The drawing can be a very large one and in order to assemble it a large number of panels of tesserae or tiles T shall be provided. Each panel contains a portion of the complete drawing. Therefore each panel might differ from the other ones as far as the arrangement of tiles is concerned. In FIG. 17 two adjacent portions of the drawing have been represented in form of a mesh. Each mesh corresponds to a set of tiles or tesserae arranged in a single panel P.

It is clear from this representation that in order to assemble tiles to form the drawing of FIG. 17 a large number of panels must be preassembled, each panel containing tiles or tesserae of different colors, for example green and white for the mountains, and blue for the sky. The drawing can be pre-stored in electronic form in a storage memory of a central processing unit and can be processed to determine the number of panels required to obtain the full drawing, the number of tiles or tesserae in each panel, the color of each tile or tessera in each panel and so on. By arranging one or more units according to the invention in a manufacturing line and by controlling them by means of the control unit it becomes possible to fill in each panel with the desired kind of tiles or tesserae and to check each panel at the end of the process to verify if all the tiles are placed in the correct position. If a unit U100 is used in an intermediate or end position along the line, individual tiles can be replaced or reversed or anyhow manipulated in order to obtain at the exit of the device the properly filled in set of panels.

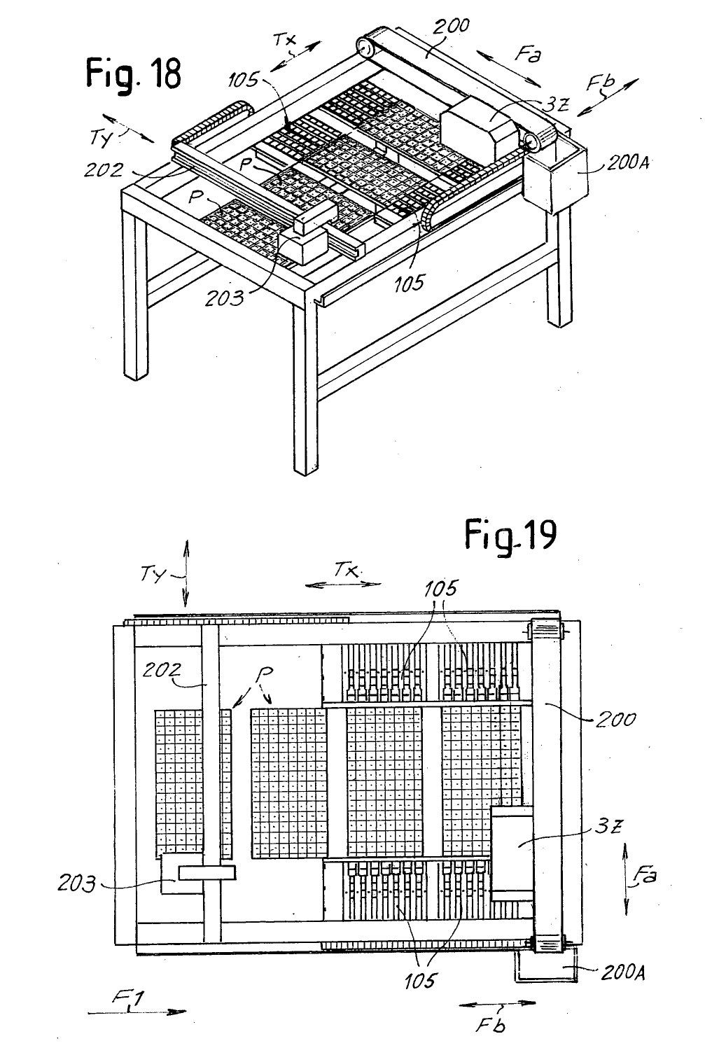

FIGS. 18 and 19 schematically show a modified embodiment of a device according to FIGS. 8A-16. The same numbers indicate components or elements which are identical, similar or equivalent to those show in FIGS. 8A-16. Reference number 3Z again designates a remover system, which can be designed as described above. The remover system is provided with a numerically controlled movement according to double-arrows Fa and Fb. In the embodiment shown a slide 200 supports the remover system 3Z and moves it along the direction Fb, said remover system 3Z being in turn movable along the slide 200 according to direction Fa. Reference numbers 105 designate a pair of storage devices arranged at both sides of the path along which the panels P advance according to arrow F1. In this embodiment two storage devices 105 are provided, in order to reduce the extension of movements which the remover system 3Z must perform. This allows for example to reduce the processing time when two panels P are advanced pair-wise in a side-by-side arrangement, as shown in FIGS. 18, 19.

In some embodiments, the slide 200 includes a conveyor belt, on which the tiles removed by the remover system 3Z are placed. The conveyor belt moves the tiles towards a collector tray 200A arranged at one end of the slide 200. This allows the operation of the device without requiring the remover system 3Z to move along an inclined plane, since the removed tiles are not discharged by gravity but are positively conveyed by the conveyor towards the tray 200A. The tiles to be removed can be handled by a device similar to the collection box 133, which may have an inclined lower surface, on which the tile to be removed is released and slides sideways until it reaches the conveyor belt.

In a preferred embodiment the remover system 3Z performs the same operations and functions as described above.

In the embodiment shown in FIGS. 18 and 19 the device further includes a carriage or slide 202 supporting a camera 203. The carriage 202 is movable according to double arrow Tx and the camera 203 is supported by a slide movable according to double arrow Ty along the carriage 202. Thus, the camera can inspect the tiles arranged in the panels P passing though the device by means of a numeric control system controlling the movement of the camera 203 in the Tx and Ty directions. Preferably, as shown in the drawings, the camera 203 is arranged upstream of the remover system 3Z with respect to the direction of advancement F1 of the panels P across the device. In this manner, it is possible to check the tiles on one or more panels by means of the camera 203 while one or more panels downstream are processed by the system 3Z. The programmable control unit, such as a computer or any other suitable unit can check by means of the camera 203 the correct filling of one or more panels P and store information on possible tiles which require to be replaced, reversed or discarded. This information is then passed to the remover system 3Z, which will process the panel after inspection thereof by the camera 203.

The above description shall be intended merely as one possible, non-limiting embodiment of the invention, which may vary in form and layout without departing from the scope of the invention. Any reference numbers in the attached claims are merely for the purpose of facilitating the understanding of the claims, reference being made to the above description and attached drawings, and shall not be construed to limit the scope of the claims.

1. A machine for filling containment panels with a plurality of sets of tiles, each of said sets of tiles having at least one pre-selectable characteristic so as to achieve a pattern in a mosaic, the machine comprising:
at least one remover system suitable for removing any of said tiles if required;
at least one viewing system designed to identify any tiles occupying positions other than as required in said containment panels based on said previously-selectable characteristics, said remover system being controlled to remove any tile occupying a position other than as required in said panel.

2-3. (canceled)

4. A filling machine according to claim 1, further comprising:
a plane for the advancement of said panels;
an advancement device for advancing said panels along a direction on said plane, wherein said at least one remover system is movable in a plane substantially parallel to a plane in which said panels are placed in said machine.

5. A filling machine according to claim 1, wherein said at least one remover system comprises a control system for moving a removal element for individually removing said tiles from said panels.

6. A filling machine according to claim 1, wherein said at least one remover system is designed and controlled to:
pick up tiles that are still not correctly positioned and replace them in a required seat of said panel;
remove tiles occupying seats other than as required in said panel;
remove tiles that are found damaged;
pick up tiles that are placed in the reverse position in a respective seat, reverse the tiles upside down, and introduce the tiles in the same seat.

7-9. (canceled)

10. A filling machine according to claim 1, further comprising at least one recovery system for recovering said tiles after removal of said tiles from the panel.

11-12. (canceled)

13. A filling machine according to claim 10, wherein said at least one recovery system comprises a sliding channel for receiving said tiles when said tiles are removed by said remover system.

14. (canceled)

15. A filling machine according to claim 1, further comprising at least one electronic processing and control system performing at least one of the following functions:
producing an electronic simulation of a mosaic generating an image or drawing divided into a plurality of said panels and of said sets of tiles;
viewing said simulation on at least one screen;
controlling said filling machine;
comparing at each step said simulation of said mosaic with the real position of said tiles on one of said panels being filled, said real position being determined by said at least one viewing system, so as to identify the position on said panels of any of said tiles that need to be removed, and sending the related coordinates of said tiles to be removed to said at least one remover system.

16-18. (canceled)

19. A filling machine according to claim 1, wherein said pre-selectable characteristic is at least one of the following: the color, the shades of color, the shape or the size of each of said sets of said tiles.

20. A filling machine according to claim 1, wherein said at least one remover system comprises at least one sucker to pick up at least one of said tiles.

21. A filling machine according to claim 19, further comprising a control system able to move said at least one remover system so as to pick up a predetermined tile from a side storage device for inserting said predetermined tile in an empty seat of said panel.

22. A filling machine according to claim 1, further comprising at least one tipping or overturning device able to reverse upside down and to drop a tile removed by said at least one remover system into the same seat, from which said tile has been removed.

23-25. (canceled)

26. A machine for filling containment panels with a plurality of sets of tiles, each of said sets of tiles presenting at least one pre-selectable characteristic in order to achieve a mosaic pattern, the machine comprising:
a final module capable of performing an automated check on said panels completely filled with said sets of tiles in order to remove and replace any of said tiles that are still not correctly positioned, or that are found damaged or placed upside down.

27. A machine according to claim 26, wherein said final module comprises at least one remover system integrally attached to a recovery channel in order to grasp such tiles needing to be removed by means of a gripping member and to release one or more said tiles into a collecting reservoir.

28. A machine according to claim 27, further comprising a storage device for containing sets of tiles, said remover system being arranged and controlled to pick up replacement tiles from said storage device and place said replacement tiles into empty seats of said panel.

29. A machine for handling tiles in a panel, the machine comprising:
an advancement path for sequentially advancing panels across said machine;
a remover system for removing and replacing tiles from and in seats in said panel;
a control unit for controlling the movement of said remover system;
a removal element on said remover system for individually removing said tiles from said panel.

30. A machine according to claim 29, wherein said remover system further includes an overturning device for turning upside down tiles which have been individually removed by said removal element from the respective seat and replacing said tiles into the seats from which said tiles have been removed in a reversed position.

31-32. (canceled)

33. A machine according to claim 29, wherein said remover system further includes a discharging device for discharging tiles removed form said panel into a recovery system.

34. A machine according to claim 33, wherein said discharging device is movable from a withdrawn position into an active position, in which said discharging device is arranged between said removal element and said panel.

35. A machine according to claim 33, wherein said recovery system includes a sliding channel into which said removed tiles are discharged by said remover element, wherein said sliding channel preferably includes a bottom wall with an aperture, across which said remover element passes to remove tiles from said panel.

36-37. (canceled)

38. A machine according to claim 29, further comprising at least one storage device for containing sets of tiles, said remover system being arranged and controlled to pick up replacement tiles from said storage device and place said replacement tiles into empty seats of said panel.

39. A machine according to claim 29, further comprising a viewing system for controlling whether the tiles are correctly arranged in said panels.

40. A machine according to claim 39, wherein said viewing system is interfaced with said control unit, said control unit controlling said remover system based on information received from said viewing system.

41. (canceled)

42. A method for sequentially filling a plurality of panels with a plurality of sets of tiles, each set having at least one pre-selectable characteristic in order to automatically produce a mosaic pattern, the method comprising the following steps:
delivering said sets of tiles onto a panel;
checking the position of each of said tiles on said panel;
removing any incorrectly positioned tile.

43. A method according to claim 42, wherein the filling steps are repeated sequentially for each of said sets of tiles on a plurality of panels sliding along a forward feed path.

44. A method at according to claim 43, further comprising:
an initial step for producing an electronic simulation of said mosaic presenting an image or drawing divided into a plurality of portions corresponding to a plurality of said panels;
acquiring an image of said panels filled with said sets of tiles;
comparing said electronic simulation with an acquired image; and
identifying on said panels the position of any of said tiles needing to be removed.

45. (canceled)

46. A method according to claim 42, further comprising the following steps:
establishing the dimensions of said mosaic, of said panels, of said tiles and of the joint gaps between said tiles and between said panels as said panels will be installed on a wall;
acquiring the image that is to be produced by means of said mosaic in an electronic format;
analyzing the colors in said image in order to convert said colors into one of the available colors most closely resembling said colors in a previously-acquired database, or acquiring the range of colors needed directly from said image and saving said colors in a color database;
viewing on screen said mosaic as said mosaic will be reproduced on said panels on the basis of the colors available, to enable a visual assessment of the end result;
establishing a sequential numbering for each of said panels and printing said sequential numbers on each of said panels so as to facilitate installation of said panels on the wall by an operator.

47. A filling machine according to claim 4, wherein said at least one remover system comprises a control system for moving a removal element for individually removing said tiles from said panels.

48. A filling machine according to claim 1, wherein the remover system is able to remove from its seat a tile which is placed upside down and to place said tile again in the same seat in the reversed position.
